(19) United States
(12) Patent Application Publication
(10) Pub. No.: US 2005/0176361 A1
(43) Pub. Date: Aug. 11, 2005

(54) Coin loader for coin dispenser canister

(76) Inventors: Victor A. Quattrini, Merrimac, MA (US); Robert J. Pitman, Beverly, MA (US); Paul O. Stump, Topsfield, MA (US); William Lemieux, Lyman, ME (US)

Correspondence Address: PERMAN & GREEN, 425 POST ROAD, FAIRFIELD, CT, 06824, US

(21) Appl. No.: 10/764,923

(22) Filed: Jan. 26, 2004

(51) Int. Cl. G07D 9/06

(52) U.S. Cl. 453/62

(57) ABSTRACT

An assembly for manually loading coins in a coin canister of coin dispenser includes a two-stage funnel mounted on a manifold for sliding motion. The funnel has an exit that aligns with tubular extensions of the manifold and the extensions align with the tubular coin stack holders of the canister. The funnel slides from stack to stack according to the size of the coin being loaded. The funnel is constructed with an internal baffle that divides the funnel passage into upper and lower stages to meter the flow of coins through the funnel.

### BACKGROUND OF THE INVENTION

1. Field of the Invention

The invention is related to automatic coin dispensers having canisters that contain an inventory of coins in stacks. More specifically it relates to a mechanism for filling the canister with coins.

2. Brief Description of Related Developments

Coin dispensers generally employ a canister for holding a supply of coins in various denominations. The coins are held in stacks within tubular receptacles constructed in the canisters. Each stack is made up of a different denomination of coin having different diameters. Filling the canisters is done manually and may become a difficult and tedious task, especially in large volume operating environments, such as super markets and the like that employ many canisters.

It is a purpose of this invention to provide an efficient mechanism for manually loading coins of different size in a canister of a coin dispenser.

### SUMMARY OF THE INVENTION

The coin loader of this application is an assembly of multiple parts that cooperate to engage a canister in preparation for the coin loading operation. A stand functions as a secure base to support the canister in an upright position. The stand is constructed with surfaces that cooperate with the geometry at the bottom of the coin canister to provide a closed, squared-off end.

A two-stage funnel functions as the coin input device. The output diameter of the funnel is designed to accommodate the largest coin denomination, thereby requiring only one funnel to service all coin sizes. In order to provide a “metered” presentation of coins to the canister, the primary opening at the top of the funnel is sized to accommodate single handfuls of coin as opposed to larger quantities that may tend to overwhelm and jam in the funnel passage. An internal ramp is constructed that separates the flow of coins into upper and lower stages. This forces the coin to cascade between the two stages and elongates the sliding path of the coins toward the funnel exit. This tends to further organize and meters the coin flow prior to entrance into the throat.

A sliding collar provides a platform to support the two-stage funnel on the fixture. The collar slides laterally across the top of the coin loader to allow the two-stage funnel to be aligned with each of the coin columns.

A funnel manifold is constructed to engage mating features at the upper part of the canister to provide a connecting passage from funnel to the coin canister. Through a series of coin column extensions, it provides a smooth transition in the coin path from a common input diameter that matches the exit of the two-stage funnel to a coin specific diameter located directly above each coin column in the canister.

A front cover has the dual function of retaining and locating the funnel manifold and also retaining and guiding falling coin and the resultant coin stack by completing the canister geometry necessary to approximate a simple tube.

A rear cover functions to complete the structure of the funnel manifold.

The coin loader of this invention can be produced to accommodate different coin sets. For this purpose, the coin loader of this application has been constructed such that only the front cover and funnel manifold are limited to a specific coin set. The remainder of the parts are intended to be common for all versions.

### BRIEF DESCRIPTION OF THE DRAWINGS

The coin loader of this invention is explained in more detail below with reference to the accompanying drawing, in which:

FIG. 1 is a perspective view of a coin dispenser;

FIG. 2 is a perspective view of the coin loader mechanism of this invention mounted on a canister;

FIG. 3 is an exploded perspective view of the coin loader mechanism of this invention;

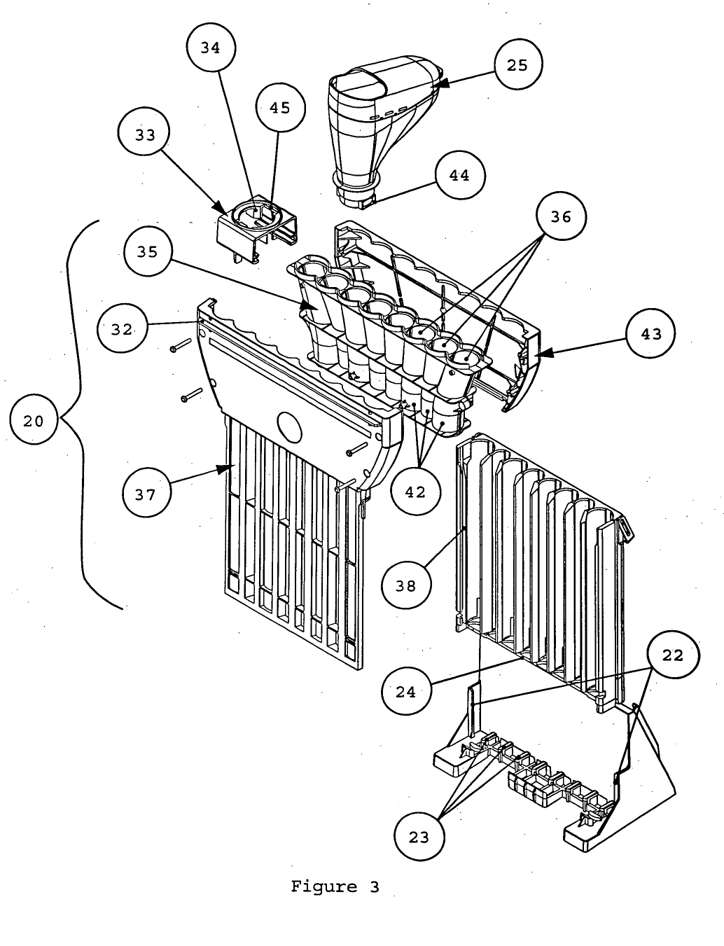

FIG. 4 is an enlarged, side, cut away view of the two stage funnel of this invention; and

FIG. 5 is a perspective view of the coin loader of this invention in the stored position.

### DETAILED DESCRIPTION OF THE PREFERRED EMBODIMENT(S)

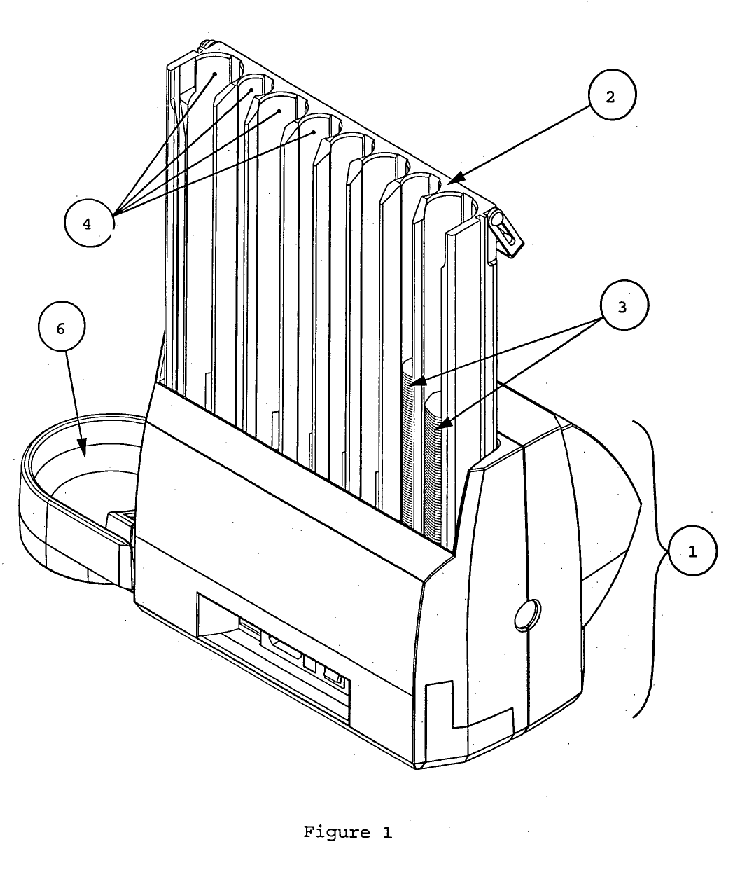

The coin loader mechanism of this invention is designed for use in a coin dispenser 1, an example of which is shown in FIG. 1. A dispenser of this type is described in detail in commonly owned, copending U.S. application for patent Ser. No. 10/199,204. The disclosure of which is incorporated into this application by reference. Coin dispenser 1 includes a coin canister 2 that contains a supply of coins 3 divided by denomination into multiple stacks. Each stack of coins is inserted into a tubular receptacle 4 from which the coins are dispensed by the action of a solenoid powered striker (not shown). The striker engages the lower most coin through an opening in the bottom of canister 2. The lower most coin is pushed out of receptacle 4 through an opening onto a ramp, the ramp allows the coin to travel out of the coin dispenser 1 to cup 6.

The coin loader 20 of this invention is constructed of multiple components that are assembled to engage a canister 2 for a coin dispenser 1, as described above. The coin loader 20 facilitates the manual insertion of coins in the canister. Stand 21 is constructed to receive canister 2 and support the canister 2 in an upright position for loading within sleeve brackets 22. It has been found that, constructing the stand 21 to support the canister 2 so that it leans slightly rearward, facilitates the loading process. The stand 21, via protruding features 23, cooperates with the geometry of the bottom surface 24 of canister 2 to square off or complete the bottom of coin column 4. Features 23 interlock with bottom surface 24 and provide a smooth floor for the coins to settle against. It has been found that this squared off configuration facilitates efficient stacking of the coins within the column 4 as they fall to the bottom of the tube during the loading operation. This reduces the occurrence of misaligned coins and jamming. The coin loader 20 of this invention is constructed to provide this squaring off function because the standard coin tubes 4 of canisters in general do not adequately approximate a squared off tube.

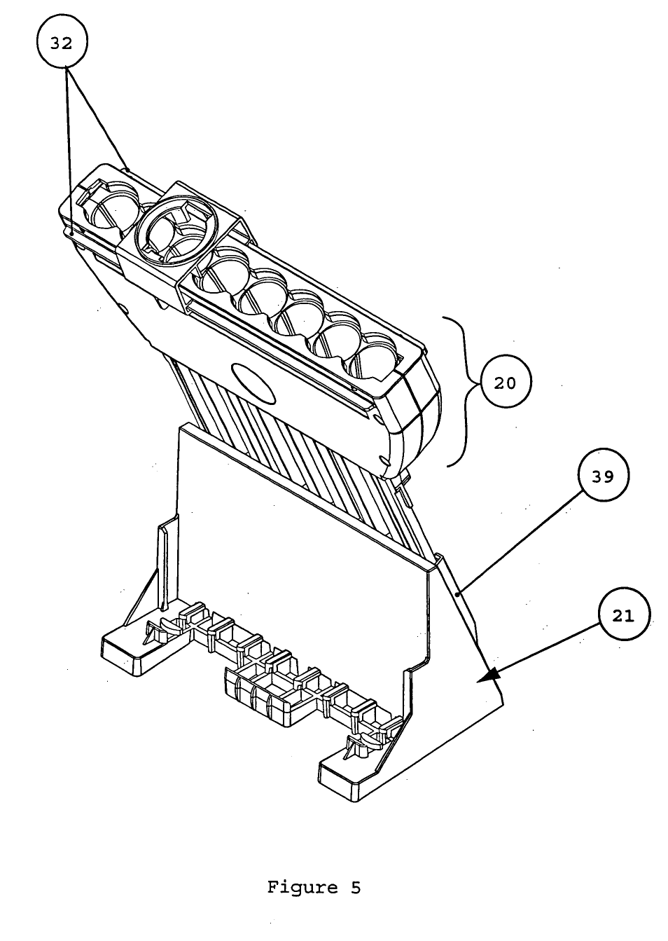

In an alternative embodiment, the stand is constructed with a set of brackets 39 which accommodate the components of the coin loader 20 when not in use. As shown in FIG. 5, the cover 37 of the coin loader 20 slides into engagement with brackets 39 for storage.

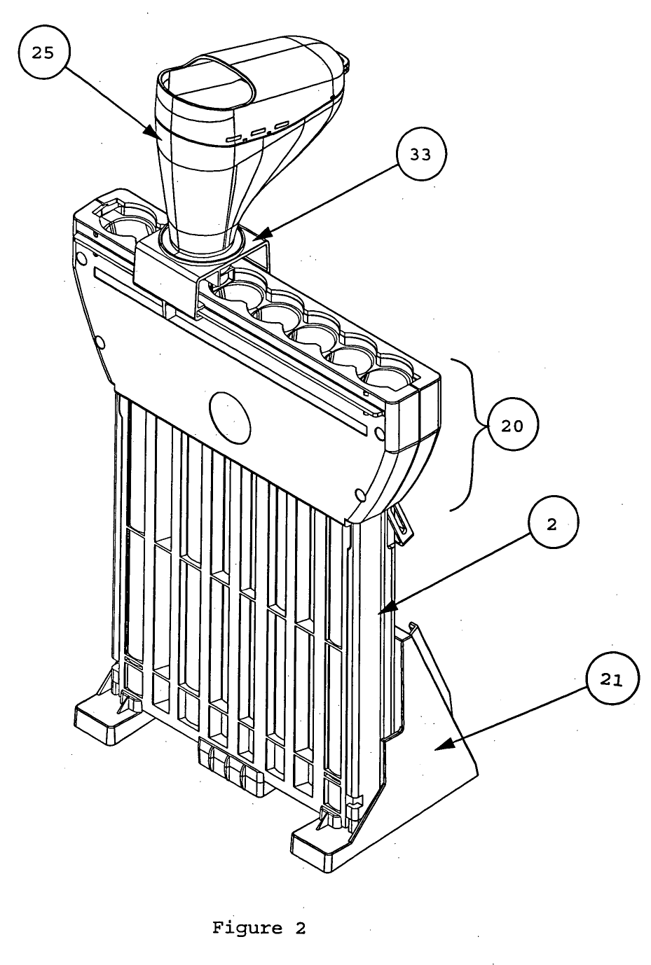

A two-stage funnel 25 is positioned at the top of the manifold 35 of coin loader 20, as shown in FIG. 2. Entrance opening 40 provides access to the passage 28 for insertion of coins. Passage 28 communicates with an exit throat 26 in spout 27. Opening 40 is sized to accommodate limited quantities of coins, for example, a cupful to avoid jamming the passage 28 or exit throat 26. The exit throat 26 of funnel spout 27 is constructed having a diameter that accommodates the largest coin denomination, of a given coin set, thereby requiring only one funnel to service all coin sizes.

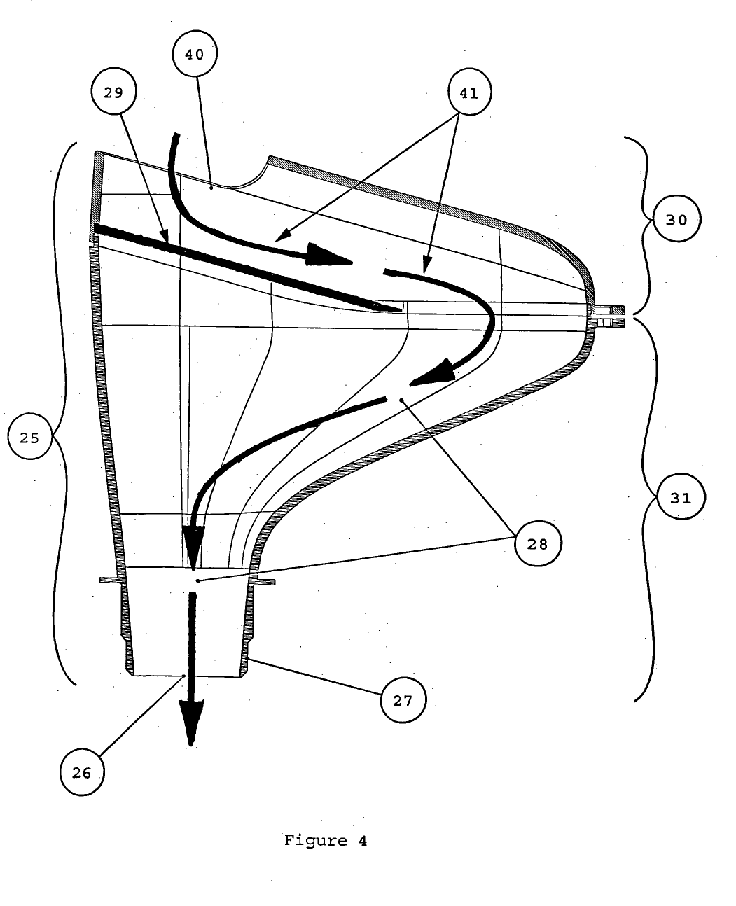

As shown in FIG. 4, coins 3 are fed to the canister 2 through funnel 25. A metered stream (as illustrated by arrow 41) is generated in passage 28 by several control factors, namely, by the limitation of the size of the entrance 40 and by constructing a baffle 29. Baffle 29 extends outward into funnel passage 28 at a declining angle to the horizontal, as shown in FIG. 4. Baffle 29 is substantially transverse to the flow of coins in the funnel passage 28 and forms an internal ramp that separates the flow of coins into upper and lower stages 30 and 31 respectively. This forces the coins to cascade between the two stages in an elongated semi-reversing sliding path, through the funnel passage 28, towards exit throat 26, as shown in FIG. 4 by arrow 41. This tends to further organize and meter the coin flow prior to exiting the funnel 25.

Supporting collar 33 is a bracket having an opening 34 to receive spout 27 of two-stage funnel 25. Spout 27 may be constructed with a key projection 44 which can be aligned with a slot 45 in the opening 34 of collar 33. The funnel 25 is inserted into the collar 33 by aligning the key 44 with slot 45 and turning the funnel 25 to lock it in the loading position. Collar 33 is mounted on coin loader 20 by means of rails 32 molded into front and rear covers 37 and 43 for sliding movement thereon. This provides a platform to support the two-stage funnel 25 above the manifold 35 of coin loader 20. The collar 33 slides laterally (horizontally as shown in FIG. 2) across the top of the coin loader 20 to allow the two-stage funnel 25 to be aligned with each of the coin columns 4.

The funnel manifold 35 is enclosed by front and rear covers 37 and 43, the covers being constructed to engage mating features at the upper part of the canister 2 to support and hold the coin loader 20 in place on the coin canister 2. Through a series of tubular coin receptacle extensions 36, manifold 35 provides a smooth transition in the coin path from a common input diameter at the exit 26 of the funnel spout 27 to a coin specific diameter 42 located directly above each coin receptacle 4 in the canister 2.

Front cover 37 is attached to manifold 35 at its upper end and is constructed to engage the front face 38 of coin canister 2 to help retain and support funnel manifold 35 in engagement with canister 2. In addition the front cover 37 provides a guide surface for falling coins and the resultant stack of coins 3 by completing the geometry of the canister necessary to make coin receptacles 4 approximate a simple tube over its height. This facilitates the proper falling and stacking of the coins from the coin loader 20.

A rear cover 43 completes the enclosure of manifold 35 and provides engagement surfaces for further securing manifold 35 to the canister 2. A rail 32 is molded into the outside surface of cover 43 in alignment with the other rail 32 of the set.

In operation, a supply of coins representing a set of frequently used denominations is organized by denomination and positioned convenient to the coin loading operation. A canister 2 for a coin dispenser 1 is installed in stand 21 in a substantially upright position. The assembled coin loader is installed onto the upright canister 2. Funnel 25 is then aligned over a coin column 4 of a selected denomination by sliding funnel 25 on rails 42. The funnel spout 27 should be fully inserted in opening 34 of collar 33 to allow the spout 27 to engage the opening of the column extensions 36 of manifold 35. To permit alignment with subsequent columns, it is necessary to slightly raise the funnel 25 to disengage spout 27 from a column extension 36 so that the collar 33 may freely slide. When each column is filled to the proper height, the operation is complete.

In this manner a coin loader is provided that improves the efficiency of loading coins into coin supply canisters for coin dispensers.

1. A device for manually loading coins in a coin canister of a coin dispenser, said canister having a series of tubular receptacles for holding a stack of coins, said device comprising:
a stand constructed to receive said coin canister and secure the coin canister in a loading position;
a funnel having a body portion and a spout portion mounted for sliding movement on said coin canister for alignment with one of said series of tubular receptacles, said funnel body having an opening to allow the insertion of coins and an internal coin passage constructed to provide a flow path for the coins to pass into said coin canister receptacles in a metered flow through an exit constructed in said spout.

2. A device for manually loading coins, according to claim 1, wherein the funnel is mounted above a manifold, said manifold constructed to releasably engage the coin canister, said manifold having a series of tubular passages for alignment with said series of tubular receptacles of said coin canister; and
wherein said funnel is moved above said manifold for alignment with one of said series of tubular passages to form a continuous passage into said tubular receptacles of said coin canister.

3. A device for manually loading coins, according to claim 2, wherein said funnel is constructed with an exit opening of a size sufficient to accommodate the largest coin of a particular set of coins and each of said tubular passages of said manifold are constructed with an upper opening of a common size with said funnel exit and a lower opening having a coin specific diameter in common with the tubular receptacle with which it is aligned

4. A device for manually loading coins, according to claim 1, wherein said funnel further comprises:
a ramp extending transverse to the coin passage to divide said coin passage into an upper stage and a lower stage to elongate the path by which the coins pass through the funnel, thereby encouraging a metered flow of coins through the funnel.

5. A device for manually loading coins, according to claim 1, wherein the stand is constructed having features which engage the tubular receptacles of the canister to square off said tubular receptacles and assist the seating of the coins as they are loaded therein.

6. A device for manually loading coins, according to claim 1, further comprising a front cover that engages said canister to provides a guide surface for falling coins by completing the geometry of the canister necessary to make said tubular receptacles approximate a simple tube.

7. A device for manually loading coins, according to claim 2, wherein the funnel is mounted on a collar and said collar is mounted on said coin loader above said manifold for sliding movement, said collar being constructed with an opening therein to receive said spout of said funnel.

8. A device for manually loading coins, according to claim 7, wherein said collar is mounted on rails molded into said front cover and a rear cover.

9. A device for manually loading coins, according to claim 1, wherein said stand is constructed with brackets constructed to receive said coin loading device for storage.

10. A device for manually loading coins, according to claim 1, wherein said stand is constructed to receive the canister and hold said canister at an angle to the vertical.
